(19) United States
(12) Patent Application Publication
(10) Pub. No.: US 2014/0284999 A1
(43) Pub. Date: Sep. 25, 2014

(54) HYBRID POWER SUPPLY APPARATUS AND METHOD FOR CONTROLLING SAME

(71) Applicant: Sang Il Kim, Gyeonggi-do (KR)

(72) Inventor: Sang Il Kim, Gyeonggi-do (KR)

(73) Assignee: DOOSAN INFRACORE CO., LTD, Incheon (KR)

(21) Appl. No.: 14/241,318

(22) PCT Filed: Aug. 20, 2012
(86) PCT No.: PCT/KR2012/006598

§ 371 Date: Feb. 26, 2014

(30) Foreign Application Priority Data
Aug. 26, 2011 (KR) 10-2011-0085850

(51) Int. Cl. B60L 1/00

(52) U.S. Cl. CPC B60L 1/00
USPC 307/9.1

(57) ABSTRACT

Disclosed is a hybrid power supply apparatus for supplying power to industrial equipment, such as an excavator. The hybrid power supply apparatus according to an aspect of the present disclosure includes: a power supply unit configured to supply power to an operating load of hybrid equipment; a hybrid controller configured to control a movement of the operating load; a control power supply unit configured to supply power to the hybrid controller; an auxiliary power supply unit configured to convert a voltage of the power supply unit and supply power to the hybrid controller instead of the control power supply unit, or charge the control power supply unit; and a first switch unit configured to connect any one of the control power supply unit and the auxiliary power supply unit to the hybrid controller.

### CROSS-REFERENCE TO RELATED APPLICATION

This Application is a Section 371 National Stage Application of International Application No. PCT/KR2012/006598, filed Aug. 20, 2012 and published as WO 2013/032159 on Mar. 7, 2013, not in English, the contents of which are hereby incorporated by reference in their entirety.

### FIELD OF THE DISCLOSURE

An aspect of the present disclosure relates to a hybrid power supply apparatus for supplying power to industrial equipment, such as an excavator, and a method of controlling the same.

### BACKGROUND OF THE DISCLOSURE

Recently, as a fuel efficiency problem of various industrial machines significantly comes to the fore due to a rapid increase in international oil prices, research is actively conducted in order to store residual power of an engine in a battery, supplement insufficient power of the engine through the battery, and improve fuel efficiency. As described above, a system, which uses an engine and an electrical motor as a common power source and includes a storage device of electrical energy, is referred to as a hybrid system. The hybrid system is widely used in various vehicles and industrial equipment, such as an excavator.

General excavator equipment performs an operation of turning or driving a boom, an arm, and a bucket, which are final loads, by using an engine as a power source through a medium, that is, hydraulic pressure. Contrary to this, hybrid excavator equipment may implement a system by connecting a motor for producing electricity to an engine of a general excavator, and additionally installing an electricity storage device, such as a battery and an ultra capacitor that is capable of storing the produced electric energy, various control circuits, and the like, thereby improving whole power efficiency.

In the meantime, an electronic control circuit for controlling a device part driven by electricity as a power source is added to the aforementioned hybrid equipment, so that it is very important to secure stability of the electronic control circuit. The reason is that when power supply is stopped during driving in a mechanical hydraulic system in the related art, an operation of equipment is immediately stopped, so that there is no significant problem, but in the case of the hybrid system, when an unexpected situation, such as generation of an error in a control circuit or turn-off of a control power source, occurs, excavator equipment may continuously drive or turn several seconds or longer, and thus severe personal and material damage may be generated. Accordingly, a stabilizer capable of preparing an error of the control circuit or the control power source is essentially demanded.

In general, a control device of hybrid equipment includes a hybrid controller, a control power supply unit, a key driver, a switch unit, and a switching mode power supply unit. The hybrid controller is also called a hybrid control unit (HCU), and controls driving of a driving device using electric energy of a battery, an ultra capacitor, and the like as a power source in industrial equipment, such as an excavator. For example, in the case of a hybrid exactor, a turning body or a boom drive unit is generally driven with electric energy. In the meantime, the control power supply unit is a battery type energy source for supplying power to the hybrid controller. The switching mode power supply unit is generally called a switching mode power supply (SMPS), and converts a voltage of the control power supply unit into a voltage with an appropriate size and supplies the converted voltage to the hybrid controller.

Reliability of the hybrid control device including the aforementioned configuration in the related art is secured under the premise that the control power supply unit for supplying a power source to the hybrid controller is normally operated without a particular problem. However, when a problem is generated in the control power supply unit itself, such as a case where a battery configuring the control power supply unit is discharged, a life of the battery is ended so that the battery is not usable any longer, a problem is generated in a battery connection cable, so that power is not smoothly supplied, and a charging device of the battery is broken down, whole equipment is not operable until the control power supply unit is repaired, and particularly, when the control power source is turned off during an operation of the excavator, so that it is impossible to control the turning body, large personal and material damage may be caused.

The discussion above is merely provided for general background information and is not intended to be used as an aid in determining the scope of the claimed subject matter.

### SUMMARY

This summary and the abstract are provided to introduce a selection of concepts in a simplified form that are further described below in the Detailed Description. The summary and the abstract are not intended to identify key features or essential features of the claimed subject matter, nor are they intended to be used as an aid in determining the scope of the claimed subject matter.

An aspect of the present disclosure is suggested to solve the aforementioned problem, and an object of an aspect of the present disclosure is to provide a hybrid power supply apparatus capable of securing stability of hybrid equipment by stably supplying operating power to a hybrid controller through an auxiliary power supply unit even though a problem is generated in a control power supply unit, and a method of controlling the same.

Further, another object of an aspect of the present disclosure is to charge the control power supply unit by using accumulated electric energy without using an alternator connected to an engine.

In order to achieve the above object, an aspect of the present disclosure provides a hybrid power supply apparatus, including: a power supply unit configured to supply power to an operating load of hybrid equipment; a hybrid controller configured to control a movement of the operating load; a control power supply unit configured to supply power to the hybrid controller; an auxiliary power supply unit configured to convert a voltage of the power supply unit and supply power to the hybrid controller instead of the control power supply unit, or charge the control power supply unit; and a first switch unit configured to connect any one of the control power supply unit and the auxiliary power supply unit to the hybrid controller.

When a reference voltage for driving the hybrid controller is not supplied from the control power supply unit, a control signal is input from the hybrid controller, or a switching signal is input from the outside, the first switch unit may connect the hybrid controller to the auxiliary power supply unit.

Further, the hybrid power supply apparatus according to an aspect of the present disclosure may further include a second switch unit configured to connect the auxiliary power supply unit and the control power supply unit, and when the auxiliary power supply unit is connected with the control power supply unit by the second switch unit, the auxiliary power supply unit may charge the control power supply unit by using a voltage of the power supply unit.

A method of controlling a hybrid power supply apparatus according to an aspect of the present disclosure, which includes a power supply unit configured to supply power to an operating load, and a control power supply unit configured to supply power to a hybrid controller for controlling a movement of the operating load, includes: detecting whether an error is generated in the control power supply unit; and when the error is detected, supplying power of the power supply unit to the hybrid controller. Further, the method may include: checking whether the control power supply unit is chargeable; and when the control power supply unit is chargeable, charging the control power supply unit by supplying power of the power supply unit to the control power supply unit.

According to an aspect of the present disclosure, the auxiliary power supply unit capable of providing electric energy accumulated in the power supply unit as operating power of the hybrid controller is provided, and when a problem is generated in the control power supply unit, the hybrid controller is connected with the auxiliary power supply unit through an operation of the switch, thereby stably supplying power to the hybrid controller. Accordingly, it is possible to improve stability and reliability of control of hybrid equipment.

Further, when the alternator connected to the engine to perform a charging function of the control power supply unit is broken down or a connection wire thereof has a problem, the auxiliary power supply unit is substituted as a charger of the control power supply unit, thereby charging the control power supply unit by using electric energy accumulated in the power supply unit. When the auxiliary power supply unit is utilized as the charger as described above, the alternator connected to the engine may be omitted, thereby decreasing an occupied area and more easily implementing a system.

### DESCRIPTION OF THE DRAWINGS

FIG. 1 is a configuration diagram illustrating an exemplary embodiment of a hybrid power supply apparatus according to an aspect of the present disclosure.

FIGS. 2A and 2B are diagrams for describing a function of an auxiliary power supply unit of FIG. 1 as a charger.

FIG. 3 is a configuration diagram illustrating another exemplary embodiment of the hybrid power supply apparatus according to an aspect of the present disclosure.

FIG. 4 is an operational flowchart of an exemplary embodiment of the hybrid power supply apparatus according to an aspect of the present disclosure.

### DETAILED DESCRIPTION

The aforementioned objects, characteristics, and advantages will be described below in detail with reference to the accompanying drawings, and thus those skilled in the art to which an aspect of the present disclosure pertains will easily carry out the technical spirit of an aspect of the present disclosure. In describing an aspect of the present disclosure, when it is determined that detailed description of a publicly known technology relating to an aspect of the present disclosure may make the subject matter of an aspect of the present disclosure unnecessarily ambiguous, the detailed description will be omitted. Hereinafter, an exemplary embodiment according to an aspect of the present disclosure will be described in detail with reference to the accompanying drawings.

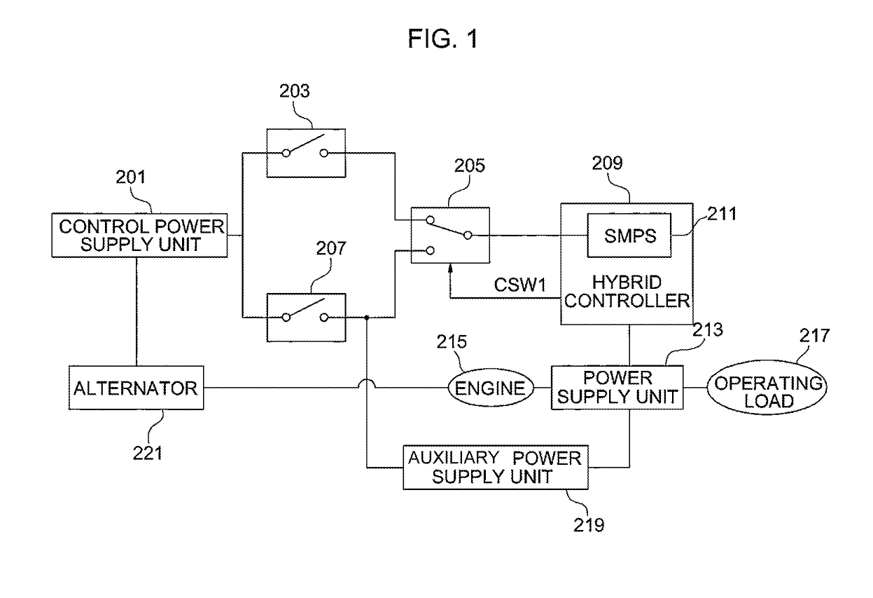

FIG. 1 is a configuration diagram illustrating an exemplary embodiment of a hybrid power supply apparatus according to an aspect of the present disclosure.

Referring to FIG. 1, a hybrid power supply apparatus according to an exemplary embodiment of an aspect of the present disclosure includes a control power supply unit 201, a key driving unit 203, a first switch unit 205, a second switch unit 207, a hybrid controller 209, a power supply unit 213, an auxiliary power supply unit 219, and an alternator 221.

The control power supply unit 201 is an electrical energy source for supplying power to the hybrid controller 209, and may be implemented by a small capacity battery with a size of 12 V, 24 V, or 48 V.

The hybrid controller 209 means a hybrid control unit (HCU) including various control circuits for controlling a movement of an operating load 217 of hybrid equipment, such as an excavator. Here, the operating load 217 means a moving unit, such as, for example, an upper turning body of an excavator, which is driven by using electric energy as a main or auxiliary power source by a hybrid system.

The hybrid controller 209 includes an SMPS 211. The SMPS 211 may step down a voltage supplied from the control power supply unit 201 to a size appropriate to drive various control circuits within the hybrid controller 209 and provide the stepped-down voltage.

The power supply unit 213 may supply power to the operating load 217 of the hybrid equipment, and include an ultra capacitor or a large capacity battery for supply power with a size of 300 V to 500 V. The power supply unit 213 may accumulate a part of energy supplied from an engine 215 in an accumulating means, such as the ultra capacitor or the battery, as electric energy and provide the accumulated electric energy as a power source of the operating load 217 as necessary.

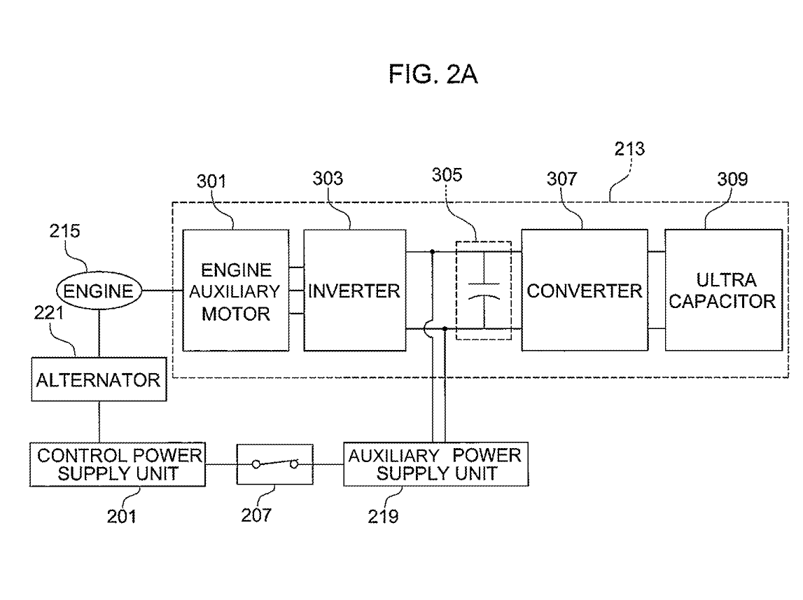

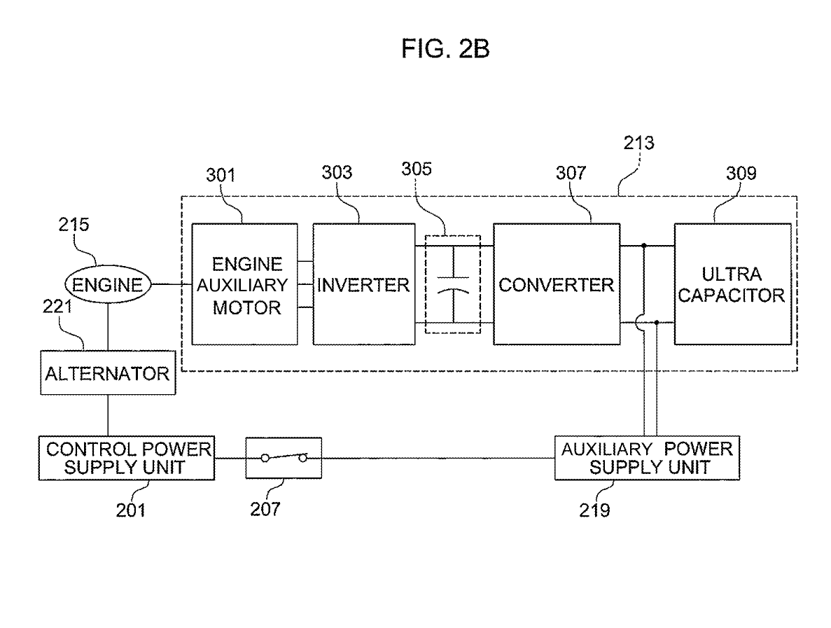

The auxiliary power supply unit 219 performs a function of supplying power to the hybrid controller 209 instead of the control power supply unit 201 when an error is generated in the control power supply unit 201, or charging the control power supply unit 201. Accordingly, the auxiliary power supply unit 219 may be implemented as a DC/DC converter capable of stepping down the voltage of the ultra capacitor or the large capacity battery of the power supply unit 213 to a voltage size of the control power supply unit 201. Further, in a case where the voltage of the control power supply unit 201 is stepped down to a voltage equal to or lower than a predetermined reference voltage, the auxiliary power supply unit 219 may also charge the control power supply unit 201 instead of the alternator 221 connected to the engine 215. This will be described in detail with reference to FIGS. 2A and 2B.

The key driving unit 203 is a switch device capable of providing control power to the hybrid controller 209 by turning on the key driving unit 203 by a driver of the hybrid equipment.

The first switch unit 205 is a switch device enabling the hybrid controller 209 to stably receive control power by connecting the hybrid controller 209 to any one of the control power supply unit 201 and the auxiliary power supply unit 219. The first switch unit 205 is connected to the control power supply unit 201 in a general operating situation, and in a case where a predetermined reference voltage for driving the hybrid controller 209 is not supplied due to generation of a problem in the control power supply unit 201, the first switch unit 205 may be switched by a control signal CSW1 of the hybrid controller 209 and connected to the auxiliary power supply unit 219. In this case, the hybrid controller 209 receives power from the power supply unit 213 through the auxiliary power supply unit 219.

The second switch unit 207 is a switch device connecting the auxiliary power supply unit 219 and the control power supply unit 201 for charging the control power supply unit 201. When the second switch unit 207 is turned on so that both the power supply units 201 and 209 are connected with each other, the auxiliary power supply unit 219 may charge the control power supply unit 201 by using the electric energy accumulated in the power supply unit 213 instead of the alternator connected to the engine 215.

FIGS. 2A and 2B are diagrams for describing a function of the auxiliary power supply unit 219 of FIG. 1 as a charger.

Referring to FIGS. 2A and 2B, the power supply unit 213 may include an engine auxiliary motor 301, an inverter 303, a DC-link capacitor 305, a converter 307, and an ultra capacitor 309.

The inverter 303 charges the DC-link capacitor 305 by the engine auxiliary motor 301. Here, the engine auxiliary motor 301 may be directly connected with the engine 215 and rotate at the same revolutions per minute (rpm) as that of the engine during driving of the engine. The converter 307 charges the ultra capacitor 309 by using electric energy stored in the DC-link capacitor 305. A detailed configuration of the power supply unit 213 and a function thereof are widely known matters, and thus further detailed descriptions will be omitted.

The auxiliary power supply unit 219 may be connected to the DC-link capacitor 305 as illustrated in FIG. 2A or connected to the ultra capacitor 307 as illustrated in FIG. 2B to receive the accumulated electric energy. Here, the ultra capacitor 307 may be substituted with the large capacity battery.

When the voltage of the control power supply unit 201 is stepped down to a predetermined voltage or lower, the control power supply unit 201 may be charged by connecting the auxiliary power supply unit 219 with the control power supply unit 201 by turning on the second switch unit 207, and driving the auxiliary power supply unit 219 as a charger. Further, in a case where it is recognized that the alternator 221 connected to the engine is broken down, the auxiliary power supply unit 219 may be used as an alternative of the alternator 221. Further, the system may be changed to have a structure of charging the control power supply unit 201 through control of the auxiliary power supply unit 219 and the switch unit 207 by omitting the alternator 221.

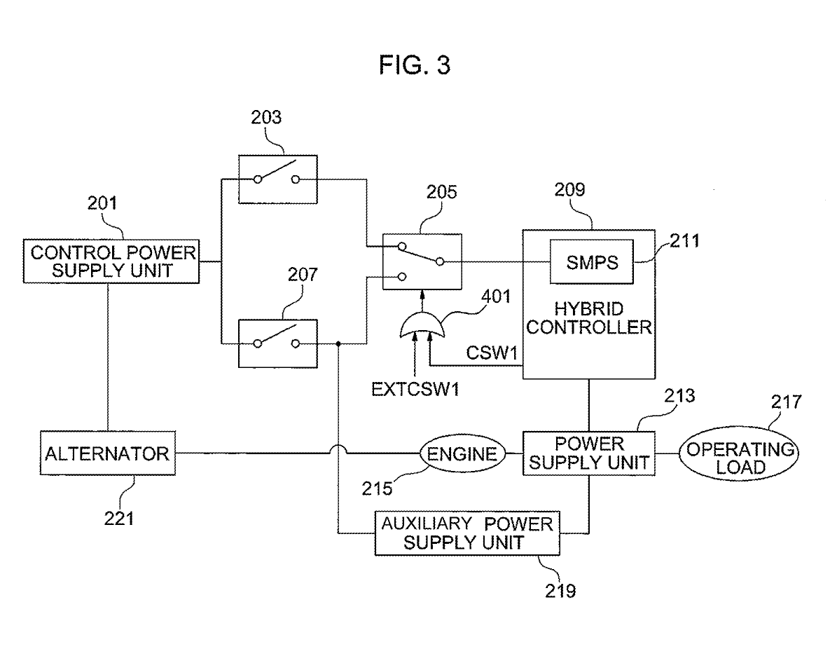

FIG. 3 is a configuration diagram illustrating another exemplary embodiment of the hybrid power supply apparatus according to an aspect of the present disclosure.

Referring to FIG. 3, a hybrid power supply apparatus according to another exemplary embodiment of an aspect of the present disclosure includes a control power supply unit 201, a key driving unit 203, a first switch unit 205, a second switch unit 207, a hybrid controller 209, a power supply unit 213, an auxiliary power supply unit 219, an alternator 221, and a switching signal input unit 401.

In the present exemplary embodiment, a control signal EXTCSW1 for a switching operation of the first switch unit 205 may be received from the outside, as well as the hybrid controller 209, through the switching signal input unit 401. Accordingly, even though starting fails due to a low voltage of the control power supply unit 201 or generation of a problem, such as disconnection, in a connection cable, the connection of the first switch unit 205 is switched to the auxiliary power supply unit 219 by applying the control signal EXTCSW1 from the outside, thereby supplying driving power of the hybrid controller 209.

Functions and operations of the remaining configurations are the same as those described with reference to FIGS. 1 and 2.

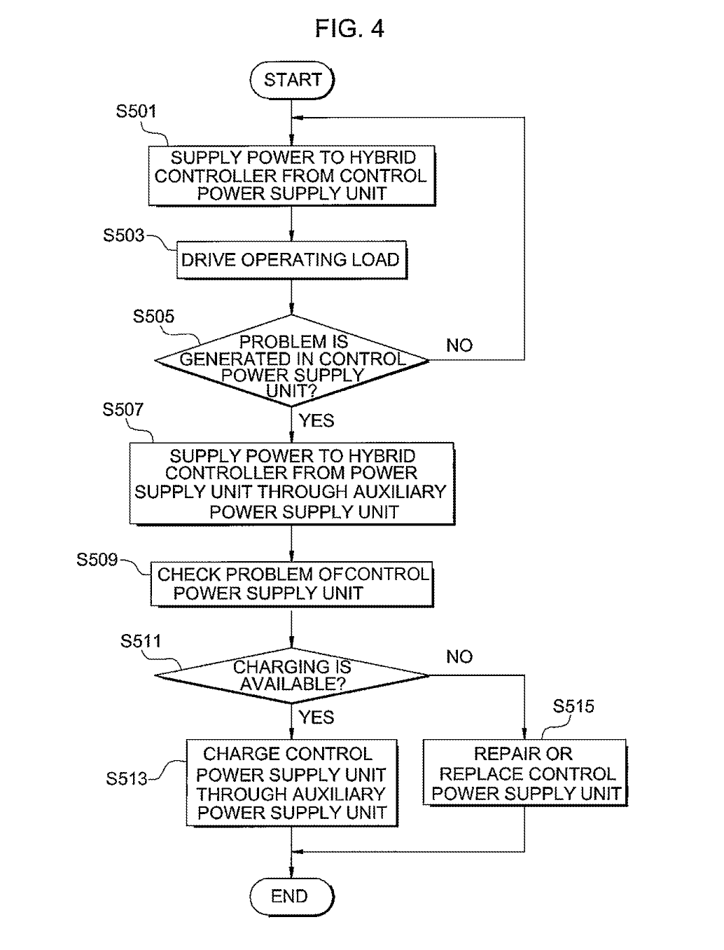

FIG. 4 is an operational flowchart of an exemplary embodiment of the hybrid power supply apparatus according to an aspect of the present disclosure.

In describing an operation process of the hybrid power supply apparatus according to an aspect of the present disclosure with reference to FIGS. 1 to 4, and first, when a driver of equipment turns on the key driving unit 203, power is supplied to the hybrid controller 209 from the control power supply unit 201 (S501), and the operating load 217 is driven by control of the hybrid controller 209 (S503). In this case, in the case where the operating load 217 is an upper turning body of an excavator, the hybrid controller 209 may control a rotation direction, an angle, a rotation speed, and the like of the turning body.

When a problem, such as a discharge of the control power supply unit 201 and cable disconnection, is generated during the operation of the hybrid equipment (S205), the hybrid controller 209 may switch the first switch unit 205 to receive power from the power supply unit 213 through the auxiliary power supply unit 219. Accordingly, even though there occurs an emergency situation in which power supply of the control power supply unit 201 is blocked during the rotation of the turning body, the operating power may be continuously supplied to the hybrid controller 209 by the auxiliary power supply unit 219, thereby safely controlling the equipment by quickly stopping the turning body and the like.

Next, a problem of the control power supply unit 201 is checked (S509), whether to charge the control power supply unit 201 is recognized (S511), and when the charging is available, the control power supply unit 201 is charged through the auxiliary power supply unit 219. For example, in a case where the alternator 221 connected to the engine 215 is failed, the auxiliary power supply unit 219 may be used as a charger. When a life of the control power supply unit 201 is ended or it is impossible to charge the control power supply unit 201 due to disconnection of the cable and the like, the problem may be solved by repairing or replacing the corresponding part (S515).

The technical spirit of an aspect of the present disclosure have been described in detail according to the exemplary embodiment, but it should be noted that the exemplary embodiment has described herein for purposes of illustration and is not intended to limit an aspect of the present disclosure. Further, those skilled in the art will appreciate that various exemplary embodiments may be made without departing from the scope of an aspect of the present disclosure.

1. A hybrid power supply apparatus,comprising:
a power supply unit configured to supply power to an operating load of hybrid equipment;
a hybrid controller configured to control a movement of the operating load;
a control power supply unit configured to supply power to the hybrid controller;
an auxiliary power supply unit configured to convert a voltage of the power supply unit and supply power to the hybrid controller instead of the control power supply unit, or charge the control power supply unit; and
a first switch unit configured to connect any one of the control power supply unit and the auxiliary power supply unit to the hybrid controller.

2. The hybrid power supply apparatus of claim 1, wherein when a reference voltage for driving the hybrid controller is not supplied from the control power supply unit, a control signal is input from the hybrid controller, or a switching signal is input from the outside, the first switch unit connects the hybrid controller to the auxiliary power supply unit.

3. The hybrid power supply apparatus of claim 1, further comprising:
a second switch unit configured to connect the auxiliary power supply unit and the control power supply unit,
wherein when the auxiliary power supply unit is connected with the control power supply unit by the second switch unit, the auxiliary power supply unit charges the control power supply unit by using a voltage of the power supply unit.

4. The hybrid power supply apparatus of claim 1, further comprising:
an alternator configured to charge the control power supply unit,
wherein the control power supply unit is disconnected with the auxiliary power supply unit, the control power supply unit is charged by power supplied from the alternator.

5. A hybrid power supply apparatus, comprising:
a power supply unit configured to supply power to an operating load of hybrid equipment;
a hybrid controller configured to control a movement of the operating load;
a control power supply unit configured to supply power to the hybrid controller; and
a second switch unit configured to connect the power supply unit and the control power supply unit,
wherein when the power supply unit is connected with the control power supply unit by the second switch unit, the control power supply unit is charged by power supplied from the power supply unit.

6. A method of controlling a hybrid power supply apparatus including a power supply unit configured to supply power to an operating load of hybrid equipment, and a control power supply unit configured to supply power to a hybrid controller for controlling a movement of the operating load, the method comprising:
detecting whether an error is generated in the control power supply unit; and
when the error is detected, supplying power of the power supply unit to the hybrid controller.

7. A method of controlling a hybrid power supply apparatus including a power supply unit configured to supply power to an operating load of hybrid equipment, and a control power supply unit configured to supply power to a hybrid controller for controlling a movement of the operating load, the method comprising:
checking whether the control power supply unit is chargeable; and
when the control power supply unit is chargeable, charging the control power supply unit by supplying power of the power supply unit to the control power supply unit.
